(19) United States
(12) Patent Application Publication
(10) Pub. No.: US 2010/0307392 A1
(43) Pub. Date: Dec. 9, 2010

(54) METHOD AND INSTALLATION FOR THE GENERATION OF EFFECTIVE ENERGY BY GASIFYING WASTE

(76) Inventor: Hermann Berthold, Weissenohe (DE)

Correspondence Address: COLLARD & ROE, P.C., 1077 NORTHERN BOULEVARD, ROSLYN, NY, 11576, US

(21) Appl. No.: 12/312,802

(22) PCT Filed: Nov. 28, 2007
(86) PCT No.: PCT/DE2007/002149

§ 371 Date: Aug. 21, 2009

(30) Foreign Application Priority Data
Nov. 28, 2006 (DE) 102006056480.4

(51) Int. Cl. F23G 5/027; F23G 5/46; F02C 3/28; F23J 15/00

(52) U.S. Cl. 110/346; 110/229; 110/235; 60/780; 110/210

(57) ABSTRACT

Disclosed are a method and an installation for generating effective energy by gasifying waste. In the method and installation, waste such as garbage is introduced into a shaft-type melting gasifier, is dried in a reverse flow, is degassed, and is gasified while the solid residue is melted. The hot crude gases that are withdrawn from the melting gasifier (15) are fed to a hot gas steam generator (18) in which steam is admixed to the hot gas and the hot gas-steam mixture is conducted across the double turbine rotor (18.13) of a turbine (18.3) that drives a power generator (18.4), a preliminary reaction taking place at the same time. The pre-purified hot gas-steam mixture is then introduced into a downflow device (38) in which the mixture is cooled and pre-purified using sprayed water mixed with reactant and by repeatedly expanding, compressing, and foaming the mixture, the pre-purified gas being withdrawn and the liquid being collected. The pre-purified gas is fed to a gas purification process (40) in which the pre-purified gas is foamed with reactant and is defoamed again. The purified gases are finally further utilized for generating power, e.g. by being burned in an engine (41).

The invention relates to a method and to a plant for generating energy through waste gasification according to the preamble of claim 1 and of claim 6, respectively.

Comprehensive efforts are already known and have been made to recover energy from diverse trash materials or waste through incineration and in particular through gasification.

A method for gasifying solid waste material in a toploader is known from DE 31 21 206 C2 wherein conventional urban waste for example is introduced into the shaft generator in a pelletized or briquetted form. A product combustion gas is generated by gasification in the toploader furnace and is washed and cooled after having left the toploader furnace. Next, this gas is cleaned in a wet scrubber so that the major part of the solids, which are in the form of particles, is collected. Said wet scrubber is adjoined with a gas washing zone after which the gas is compressed in a gas compressor. Finally, about 20° of the dried product gas obtained is forwarded to an incineration zone for generating energy for the plant, whilst the major part of the product gas is caused to exit the plant as an end product thereof in order to be processed further. The energy yield is relatively small in this relatively complex plant, the more so as it seems that the electric supply must occur from the outside.

A method for gasifying solid waste material in a shaft generator is known from U.S. Pat. No. 3,729,298 wherein the extracted raw gas is washed and cooled and the dust and condensate loaded cleaning liquid is separated into an aqueous and an organic phase. After filtration, part of the aqueous phase is recirculated into the wash zone and the remaining part of this phase is led out of the process whilst the filtered solid matter is mixed with the organic phase and is recirculated into the shaft generator.

Further, it is known from DE 25 50 205 A1 to gasify waste under pressure with oxygen and to integrate thereby into the method an air fractionation plant, the waste being loaded in a pelletized form, as needed. Hydrocarbons are separated from the gas water in the condensates resulting while the raw gas is cooled down and are introduced into the generator in the region of the melting zone thereof. The solid gasification residues are incinerated.

Finally, a waste gasification method working with the incineration of the solid residues is known from U.S. Pat. No. 3,817,724 wherein the raw gas is washed with a mixture of fresh water, alkali carbonate and a recirculated part of the dust and condensate loaded cleaning liquid. Deposited solid matter is recirculated as the slurry into the carburetor together with a small portion of the cleaning liquid whilst a small oil stream and cleaned raw gas are combusted for generating electric energy. Moreover, part of the raw gas is combusted with air or oxygen and the thus generated hot combustion gas is fed into the carburetor.

It is the object of the invention to indicate a method and a plant of the type mentioned herein above through which a maximum of effective energy is obtained while optimally avoiding contaminated waste water and exhaust gas.

This object is achieved in accordance with the invention by a method exhibiting the characterizing features of claim 1. Advantageous embodiments are characterized in the corresponding dependent claims.

According thereto, the hot raw gases drawn from the smelting gasifier are supplied to a hot gas steam generator wherein steam is added and mixed with the hot gas and this mixture of hot gas and steam is led through the double rotor of a turbine that drives a current generator, a pre-reaction taking place at the same time. Then, the pre-cleaned hot gas-steam mixture is introduced into a downdraft apparatus in which the mixture is cooled and pre-cleaned using injected water mixed with reaction agents and repeatedly expanding and compressing the mixture with foaming, the pre-cleaned gas being carried away and the liquid, collected. Moreover, the pre-cleaned gas is led to a gas cleaning stage in which the gas is foamed with a reaction agent and defoamed again, the cleaned gases being finally supplied to further energetic use e.g., for combustion in an engine.

Generally, a very efficient method yielding a maximum amount of gas and generating a maximum of effective energy is provided while maximally avoiding environmental impact.

An advantage is obtained if, by arranging a guide cylinder provided with radially roofed perforations in the gasification zone of the smelting gasifier, the material to be gasified glides downward in the guide cylinder whilst the released gases flow upward in the gas-carrying channel, thereby also passing radially through the perforations. As a result, the downward sinking gasifying and melting mass will no longer contact the outer surface of the carburetor housing so that damage is avoided and the waste is additionally prevented from becoming blocked. Also, the generated gases have the possibility to rise in the gasifying material or to increasingly exit radially into the annular guide channel and then to flow unhindered, directly upward. It is thus made possible that the gases, which already outgas at 60° C., will mostly not mix with the higher temperature gases flowing upward via the annular guide channel until they arrive in the zone of the suction pipe leading further. Moreover, a steam-gas mixture, which is not explosive and may be drawn through the negative pressure prevailing in the evacuation pipe, forms in the upper region.

Another advantage is that in the method of the invention for operating a generator by hot gas carried through the double rotor of a turbine and which is obtained from the carburetor (smelting gasifier) of a waste incinerator plant, steam (high-pressure hot steam) is introduced or generated upstream of the turbine, i.e. immediately before the entrance of the turbine, and this in such a manner that this steam enters together with the hot gas, concurrently mixing therewith, directly before the turbine entrance into the turbine at high pressure. Then, this hot gas-steam mixture is introduced with very high density and at high speed through the turbine inlet, which narrows with respect to the last portion of the gas supply, this mixture expanding first through the double rotor of the turbine and then being compressed again, a pre-reaction taking generally place in the mixture as a result thereof. Then, the hot gas-steam mixture exits the small diameter portion, similar to that of the entrance of the housing port, and flows into a flaring diffusion portion of the following drain pipe, the mixture then expanding again whilst negative pressure prevails in the drain pipe.

Through the high-pressure hot steam generated in the high-pressure tank of the apparatus (referred to herein after as hot gas steam generator, short: HGDG), i.e., of the hot steam generator a two-pass radial compressor (known as turbine effect from power train engineering) is driven as a result thereof, the negative pressure at the output of the turbine causing suction to occur so that blackflow is not possible. Through this negative pressure in the drain the flow does not back up in the system as far as the carburetor. This simultaneously also relieves the carburetor in the process so that there is no outgassing either, which would result in leaks in the flange joints, in particular in the turbine inlet and in the turbine housing.

Another advantage is that, in order to generate the high-pressure water steam, cleaned and, as a result thereof, lime-free process water is introduced into the turbine inlet in the center thereof, said water being supplied e.g., from the water cleaning system of the waste incineration and processing plant. This lime-free water is caused to evaporate through the hot gas, hot and raw gases then mixing with the steam and being brought to undergo a pre-reaction. This may advantageously occur by the fact that the water is introduced into a high-pressure tank located concentrically in the balloon-like flaring inlet and opening toward the turbine inlet in a pear-like fashion, hot gas flowing around said high-pressure tank. The high-pressure steam generated in the tank exits at high speed in proximity to the turbine entrance, mixes with the hot gas flowing past it outside thereof and enters the turbine at high speed while the hot gas and the steam further mix so that pre-reaction takes place as a result thereof.

The turbine, which is driven by the energy of the hot gas-steam mixture, then further drives the generator, preferably a permanent magnet generator, through its drive shaft. Preferably, this generator may be configured to be multi-stage, meaning that it may be added to the circuit or commuted for different torques, according to the torque received from the turbine. The direct current generated by the generator is preferably used, i.a., for physical separation with electrolytic fractionation of the contaminated water (process water) of a waste incineration and processing plant. The thus generated excess oxygen and hydrogen is thereby used for further use in the plant, and is preferably led to the auxiliary burner of the carburetor or to an internal combustion engine for corresponding effective energy generation (increase of primary energy). Part of the generator flow may of course also serve for supplying the system, e.g., the pumps thereof.

The object is further achieved by a plant for carrying out the method described herein above, with characterizing features of claim 6. Advantageous embodiments are characterized in the corresponding dependent claims.

Accordingly, a guide cylinder provided with radial ports is disposed in the interior of the gasification zone of the smelting gasifier, concentric with, and spaced from, the outer surface of the carburetor housing, in such a manner that the material to be gasified is caused to move downward inside the guide cylinder whilst the exiting gases enter into the annular gas-carrying channel formed between the guide cylinder and the outer surface of the carburetor, and are evacuated upward. As a result, the downward sinking gasifying and melting mass will no longer contact the outer surface of the carburetor housing so that damage thereto is avoided and the waste is prevented from getting blocked. Additionally, the generated gases have the possibility both to ascend in the gasifying material and to increasingly exit radially into the guide channel and to then flow directly upward, unhindered. The same applies to the high-temperature gases of the lowermost carburetor section. Additionally, and as a result thereof, the material supplied at the top will not be unnecessarily heated by ascending hot gases so that gases already outgassing at 60° C. will mostly not mix with the higher-temperature gases until they reach the zone of the suction pipe leading further. Additionally, a steam-gas mixture, which is not explosive and may be drawn by the negative pressure prevailing in the evacuation pipe, forms in the upper part. As a result, a gas with an optimal temperature is generally output.

An advantage is obtained if the radial ports of the guide cylinder comprise roof-shaped covers that are pressed out and inclined at an angle of about 5° to 20°. These covered ports can be formed by making arcuate notches into the cylinder jacket, said notches being then slightly pushed or bent inward. As a result, there is a roof above the thus made port so that the port is protected against the sinking material and so that a flow out assistance for the gases is formed at the same time.

Finally, it is advantageous if the guide cylinder ends at its upper end above the border of the hot gas evacuation pipe, preferably approximately in the center thereof. The upper border of the guide cylinder may thereby flare conically so that this border applies radially substantially as far as the outer surface of the housing. As a result, it is avoided that material, which is supplied from the top, penetrates into the annular gas-carrying channel, causing damage and making it more difficult for the gas to flow out.

An advantage obtained is that a balloon-shaped or pear-shaped housing is mounted upstream in the inlet of the turbine of the hot gas steam generator of the plant or that a housing, which flares in balloon or pear-like fashion when compared to the supply pipe and the turbine entrance, is mounted intermediate the turbine entrance and the inlet pipe. A substantially pear-shaped high-pressure tank is arranged concentrically in the housing so that its narrowed outlet port is directed toward the turbine entrance and is located in immediate proximity thereto. The high-pressure tank is thereby connected to a water inlet, said water inlet opening out, preferably centrally/axially, into the tank. The hot gases, which flow about the high-pressure tank outside thereof, heat the tank accordingly, so that the water introduced into the tank evaporates explosively and that this steam exits the high-pressure tank and enters into the immediately following turbine port, with the corresponding high pressure. The flue gas, which is flowing past, is thereby mixed therewith and thereunder, an optimal mixing and pre-reaction of the gas-steam mixture taking place thereafter thanks to the different pressure and speed conditions during expansion, compression and renewed expansion.

The steam formation in the high-pressure tank is also optimized accordingly if the water, which is centrally introduced into the high-pressure tank, is injected or introduced in such a manner that it is evenly finely distributed substantially radially so that the steam generated by the action of great heat forms relatively constantly compared to the cross section of the tank so that the pressure load can be kept quite even also.

For this purpose, a manifold disc can be provided, which is supported in the water-carrying pipe through so-called water bearing, the water inflowing through the water bearing axially impinging said disc and being evacuated radially. The manifold disc is caused to rotate through tangential or spiral-shaped embossments that are provided on the side of the manifold disc struck by the water and that serve as water guiding edges, so that the impinging water additionally experiences a movement of rotation and is tangentially centrifuged toward the hot inner wall of the tank. If there is also provided a three-point water bearing, with two bearings before and one behind the manifold disc, said manifold disc is kept stable so that wobbling is not possible. The amount of exiting water adjusts automatically according to the primary pressure prevailing at the delivery pump, before and behind the disc. As a result, the amount of steam to be mixed into the hot gas becomes controllable in a simple way.

Another advantage is obtained if the drain pipe has a diffusion portion flaring in the drain direction on the turbine side, so that the positive effects are even further increased or carried on through consecutive compressions and expansions of the gas carried therethrough. Next, this drain pipe is connected to a gas cleaning stage, through the exhaust fan of which an negative pressure is applied in the drain pipe, said negative pressure affecting the entire function of the apparatus of the invention, but optimizing in particular also its permanent operability. As a result, no backflow through the turbine to the carburetor can take place in the system on the one side, so that the gasification process is thus relieved. On the other side, outgassing of the housing gaskets in particular and, as a result thereof leaks in the flange joints, in particular in the turbine inlet and turbine housing, are avoided.

It is particularly practical if the apparatus of the invention is incorporated in an effective energy production and waste incineration and processing plant, its inlet being connected to the waste carburetor (smelting gasifier) and carrying the raw/hot gas generated therein. The outlet of the apparatus or of the turbine of the apparatus is thereby connected to a gas cleaning apparatus the fan of which generates the negative pressure in the inlet, as described above. The driven shaft of the turbine is thereby connected to a generator, preferably to a permanent magnet generator, that has preferably several stages for selective operation depending on the torque transmitted so that a corresponding optimal function is always possible. The generator in turn is electrically connected to a physical separator for contaminated water, in particular for the waste water occurring in the waste silo, the direct current of the generator serving to electrolytically decompose the water. The excess oxygen and hydrogen obtained thereby is then used as primary energy in the system, on the one side in the auxiliary burner of the carburetor (the oxygen O₂) and on the other side in the internal combustion engine of the plant (the hydrogen H₂).

Finally, it is also particularly advantageous if the water inlet of the pressure tank of the hot gas steam generator is connected to a water tank which contains cleaned process water from the water reservoir of the water cleaning stage of the plant as well as the water condensed in the turbine. Since the process water originating from the water cleaning stage of the system is practically clean and no longer contains any impurity nor calcium, there are no deposits, neither in the high-pressure tank nor in the turbine mounted downstream thereof, this participating in lengthening the life and in reducing the need for maintenance work.

The invention will be understood better upon reading the following description of several embodiments of the plant and of parts thereof with reference to the drawings. In said drawings:

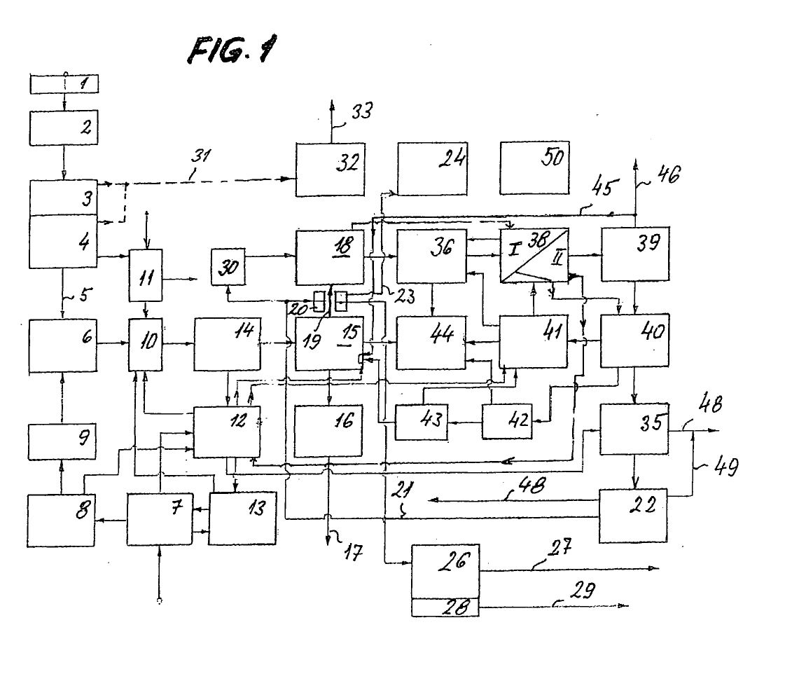

FIG. 1: shows a schematic illustration (block diagram) of a plant suited for the present method,

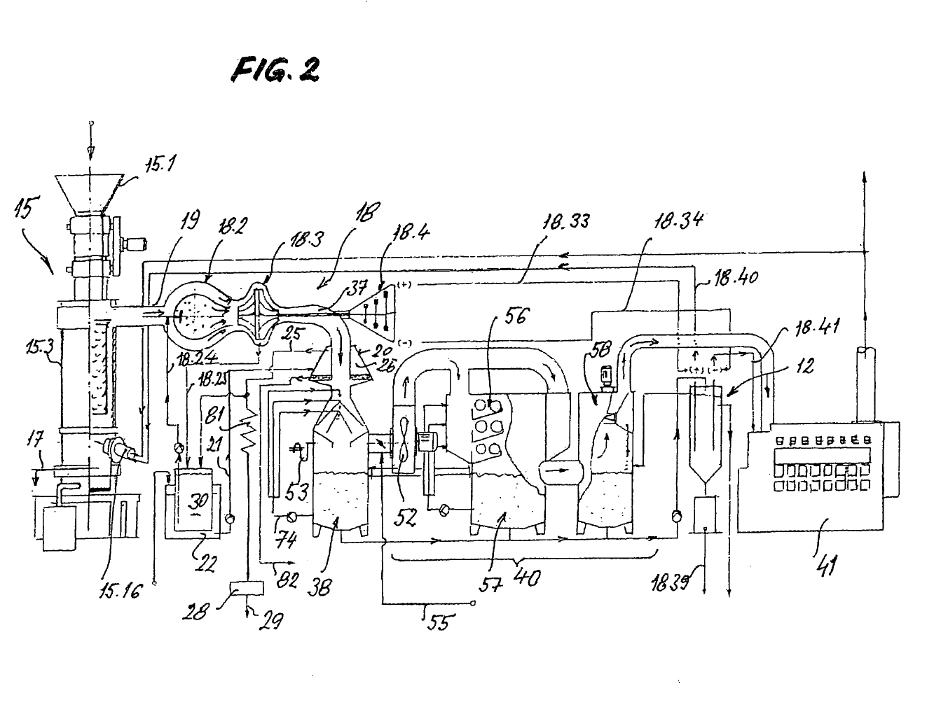

FIG. 2: shows a schematic illustration of a detail of the plant shown in FIG. 1,

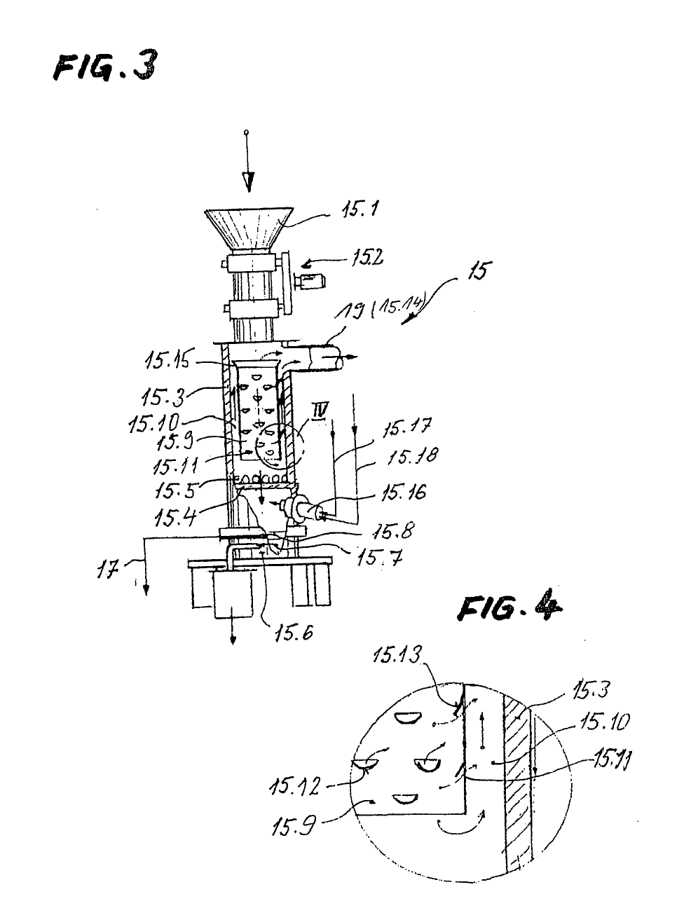

FIG. 3: shows a partial vertical section through a smelting gasifier,

FIG. 4: shows a detail IV of FIG. 3,

FIG. 5: shows a schematic illustration in a partial sectional view through the hot gas steam generator of the plant, with connection to a process water tank and to a physical separator,

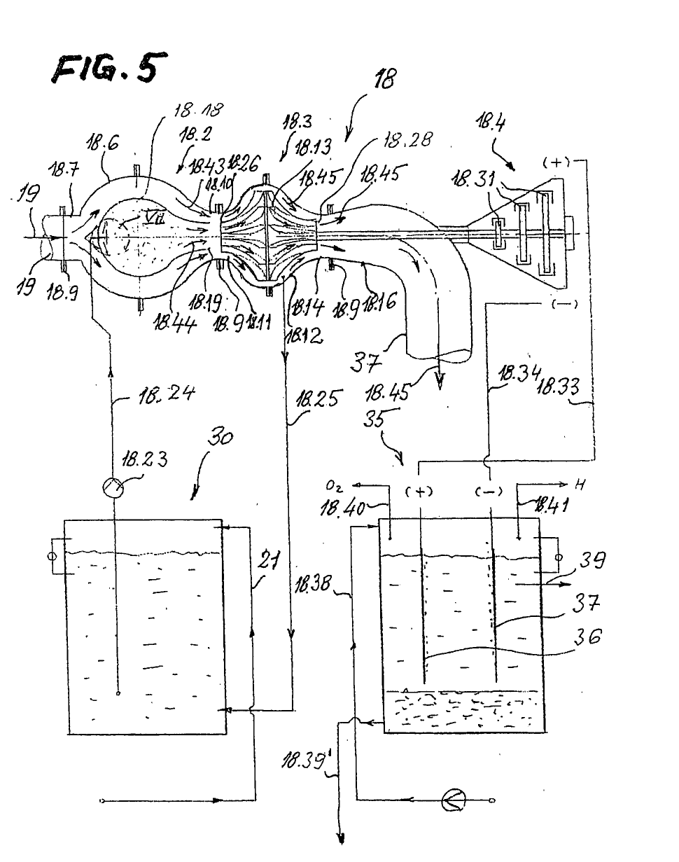

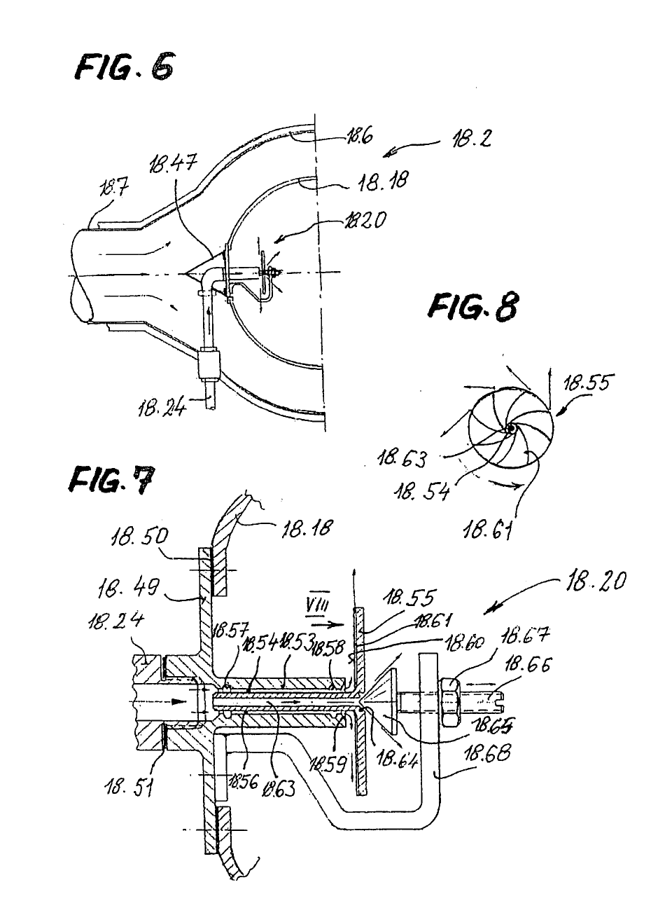

FIG. 6: shows a partial sectional view through the steam generator shown in FIG. 5,

FIG. 7: shows a detail VII of FIG. 5, illustrating the water distributor, and

FIG. 8: shows a view according to arrow VIII of FIG. 7 of the manifold disc.

As can be seen in FIG. 1, the raw waste or trash is brought and introduced into the plant with a truck, said truck first driving through a water bath 1 in order to wash the truck tires and to thus prevent germs and bacteria from being brought into the subsequent sluice. Then, the truck drives onto a scale 2 by which the supplied trash is weighed and booked in.

Next, the truck drives into a sluice 3 in the space of which negative pressure prevails. A bunker 4, into which the trash is dumped or tipped by the truck, directly adjoins the sluice 3. For this purpose, the truck drives backward into the sluice until it reaches the bunker collar; then, the bunker gate opens. The trash tipped into the bunker is then transported into a crusher 6 by means of a conveyor belt 5. In this crusher 6, the trash is crushed only coarsely. Then, slurry is supplied from a slurry silo 7 via a slurry dehydration device 8 by means of a conveyor 9 and is mixed with the crushed material, this mixture being then supplied to a piston press 10.

A metal separator 11 for cutting coarse metal parts is mounted above the conveyor belt in the bunker 4. The rest is supplied to the piston press 10.

By means of the piston press 10, all the solid matter from the crusher 6, the rest from the sieve and metal separator 11 as well as diverse slurry residues from the slurry silo 7, of the slurry dehydration device 8, of a physical separator 12 and of a chamber filter press 13 are pressed together and supplied to the trash storage hopper 14.

The substances are pressed in such a manner in the piston press 10 that a tubular piston forms. This tubular piston, or the mass of raw material, is sealed on the outside through the high pressure (of up to 100 bar) so that the trash needs no longer be shrink-wrapped in bales. The tubular piston of trash thereby has a hollow space in its center, which makes it possible to evacuate evenly the carbon and the hydrocarbons when smouldering the substances (surface enlargement). The dimensions of the hollow pistons may thereby be Ø 300×400 mm. As a result, it has been made possible to obviate the need for presorting the trash.

The trash storage hopper 14 performs the part of an intermediate buffer from which the corresponding, prepared and bunkered trash is supplied to a smelting gasifier 15. This carburetor 15 is described in closer detail with reference to FIG. 2 and in particular with reference to FIGS. 3 and 4. The slag is drawn from the bottom part of carburetor 15, brought to a slag processing stage 16 from where it is evacuated accordingly via a line 17.

At the upper gasification zone, the hot gas generated is evacuated and supplied to a hot gas steam generator 18 that will be discussed in closer detail with reference to FIG. 2, but in particular with reference to FIGS. 5 through 7. The line 19 leading from the carburetor to the hot gas steam generator is enclosed by an annular housing 20 into which process water contained in a water reservoir 22 is introduced via a line 21. The steam generated thereby is supplied to cold and ice production stage 24 via a line 23 whilst the heated water is brought to desalination 26 via a line 25. Next, desalinated water is evacuated through the line 27 and/or is at need passed through a filter 28 and then carried further in the line 29 in the form of drinking water.

Through the very good tuning of all the physical and technical variables in the plant system, it is now possible to desalinate in an economically sensible way e.g., sea water and salt-loaded industrial water such as e.g., fish water. This occurs as follows for example:

The salt-loaded industrial or sea water is supplied to a water cleaning system 35 such as the one described in EP 0 549 756 B1 for example. The rest of the salts contained in the solution is then carried through the evaporation path in the annular housing 20 and is evaporated with the secondary heat of the raw gas flow coming from the smelting gasifier 15. Then, the steam is condensed and the thus desalinated water is used in the plant system or can be returned to nature as cleaned water.

The process water drawn from the water reservoir 22 via the line 21 is caused to flow into a water tank 30 from which it is introduced into the steam generator of the hot gas steam generator 18 for steam generation, as is shown in detail in the FIGS. 5 through 7 in particular. From the sluice 3 and the bunker 4, as well as from other stages of the plant and the hall supply, the exhaust air is caused to flow through e.g., a line 31 into an air cleaning stage 32 from which the cleaned exhaust air exits or is evacuated through the line 33.

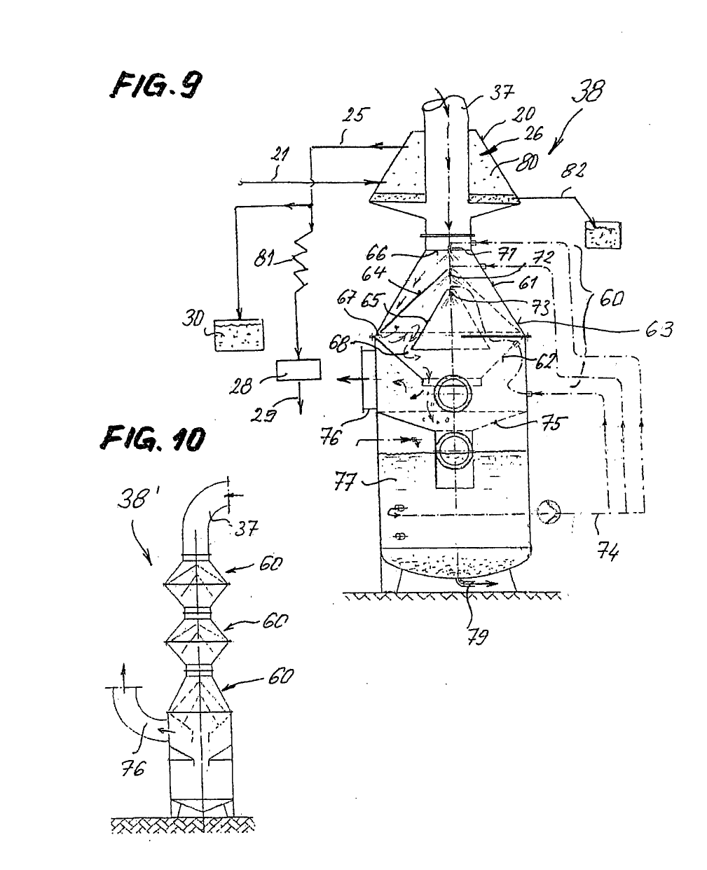

The hot gas steam generator 18 communicates with a thermal oil exchanger 36 which in turn is in interacting connection with a downdraft apparatus 38. The hot gas steam generator 18 may also communicate with the downdraft apparatus 38 through a direct line 37. Structure and function of the downdraft apparatus will be discussed in closer detail herein after with reference to FIG. 2, FIG. 9 and FIG. 10.

The gas released from the downdraft apparatus 38 in which the pre-reacted gas-steam mixture, which was supplied by the hot gas steam generator 18, has been pre-cleaned is transmitted to a gas cleaning stage 40 that will be described in closer detail with respect to FIG. 2, as substantially described in EP 0 549 756 B1.

The gas cleaned therein is then supplied to either a motor or a turbine 41, a water processing stage 35 or a gas liquefier 42. From the gas liquefier 42, the liquid gas is then supplied to a supply tank 43 and from there to the burner of the carburetor 15 or the liquid gas is supplied to a central heat absorption and distribution stage 44 which additionally communicates with the motor 41, the thermal oil exchanger 36 and the carburetor 15.

Gases or gas mixtures originating from the motor 41 are led through the downdraft apparatus 38, are cooled and cleaned and then led into an exhaust cleaning stage 39. From the exhaust cleaning stage 39, the cleaned exhaust gases are supplied to the gas cleaning stage 40, to the burner of the carburetor 15 or released via a line 46. The water drawn from the physical separator 12 is caused to flow via the line 47 into the water processing stage 35 and from there the cleaned water is brought to the water reservoir 22 and from there to the plant supply, through line 48 for example. From the water reservoir 22 a line 49 leads into the line 48, which evacuates the excess water into a discharge system or into other public/free waterbodies, such as a brook or a river. Finally, a heat exchanger is provided for the plant supply 50.

The plant shown in FIG. 2 comprises essential parts of the plant described with reference to FIG. 1, different supplies and evacuations or transport systems having not been taken into consideration or represented. On the left side of the Fig. a smelting gasifier 15 can be seen, which will be described in closer detail herein after with reference to the FIGS. 3 and 4.

At the top side of its fusion zone the smelting gasifier 15 is connected via a drain or inlet pipe 19 to the hot gas steam generator 18 which will be described in closer detail herein after with reference to the FIGS. 5 through 8.

The hot gas-steam mixture is supplied from the top via the drain pipe 37 into the downdraft apparatus 38 that will be discussed in closer detail with reference to the FIGS. 9 and 10. Since the primary energy of the trash introduced into the smelting gasifier differs, the quantity and composition of the gas generated is also different. Through the effect of the transition from a solid aggregate condition (trash) into a gaseous one (carburetor), a pre-reaction of the gasses takes place on the way via the hot gas steam generator 18 and the downdraft module 38 to the gas cleaning plant 40.

By means of an exhaust fan (52) upstream of the gas cleaning stage 40, a negative pressure is maintained in the downdraft module (38) by a negative pressure dosimeter (53). The quantity of gas and the calorific value contained therein is measured by an air-gas controller (54) upstream of the exhaust fan (52).

Air oxygen is drawn accordingly from the suction device of the physical separator (12) through an air line (55). The thus obtained gas-air mixture is caused to flow into the gas cleaning plant (40), which possesses a foam generator (57) and a foam decomposition device (58) where the gases are now adsorbed and absorbed.

A very large mass of foam is formed by means of the dynamic cylinders (56) of the foam generator (57) provided in the gas cleaning stage. The filter surface reached thereby has an area of about 100,000 m² when 1 m³ is formed per unit of time for example. This area is sufficient to release the cleaned hydrocarbons the motor (41) for example needs for combustion. This occurs as follows:

By means of a reactant that is dosed and added to the water one obtains a so-called process liquid that is permanently circulated in the circuit via the cylinders (56). The foam mass forms when the gas-air mixture is supplied. Due to the high affinity, the reactant has the property of causing long-chain compounds such as Undecan (C11 H24), which forms from trash during gasification and binds other substances such as naphthalenes and silicanes, to deposit. These substances then form a slurry and are no longer given into the cleaned gas stream flowing to the motor (41). Short-chain compounds such as methane (CH₄), methanol (CH₄O) or isopropanol (C₃H₈O) and so on, by contrast, are again released into the gas stream flowing to the motor once cleaned. This occurs through the steam pressure, which through the temperature control from the central heat absorption and distributor (44) over the heat exchangers.

The advantage of mounting the gas cleaning stage upstream of the motor (41) is that no lambda control is needed any longer for combustion in the motor and that a higher overall performance of the motor is achieved since the gases have been cleaned. The amount of gas supplied to the motor is always the same thanks to the fact that the foam mass generated has always the same volume and that the process water temperature is controlled. The liquefied excess gas is liquefied by means of a distillery (gas liquefaction) (42). Moreover, no explosive gas-air mixture forms over the entire gas conduction path since the entire path to the motor is a wet cell region and since the relative air humidity does not fall below 80%.

It can also be seen from FIG. 2 how the water tank 30 is disposed in the water reservoir 22 so that there is provided a heat buffer. The heat of the hot water condensed out of the turbine 18.3 and of the desalination device 26 is thus better preserved in the water of the tank 30 and is only delivered partially to the process water of the reservoir 22 so that it remains in the system.

As can be seen from the FIGS. 3 and 4, the smelting gasifier 15 of the invention comprises on its upper side a hopper 15.1 for introduction or supply of the material to be gasified such as waste or trash.

Below, there is a gate system 15.2 in which two gates allow for portioning or separating the material fed into the gasifier. Farther down, there is a water-filled housing jacket 15.3 that is bounded at the bottom by a grate 15.4 for ceramic high-temperature beads 15.5 to rest on, the molten residual material flowing between said beads downward into the combustion chamber and from there into a collecting tray 15.6. The heavier liquid metal alloys 15.7 are collected at the bottom of this collecting tray whilst the liquid, inert slag 15.8 floats at the top, and both, meaning the liquid metal alloy and the liquid slag, may be accordingly evacuated and brought to their further utilization.

Inside the housing jacket, a guide cylinder 15.9 is disposed concentrically and at a distance so that an annular gas-carrying channel 15.10 is provided therein between. Roofed ports 15.11 are made in the guide cylinder 15.9; this can be seen from FIG. 4 in particular. These ports 15.11 are formed by the fact that arcuate notches 15.12 are made in the jacket of the guide cylinder, a roof 15.13 for protecting the respective ports 15.11 being provided by embossment or bending.

As can be seen in particular from FIG. 5, the hot gas-steam generator 18 has the following significant parts, seen one after the other: a steam generator 18.2, a turbine 18.3 and a generator 4. The steam generator 18.2 has a balloon-like housing 18.6 that is connected on its one side to an inlet pipe 19 carrying raw gas or hot gas from the carburetor via its inlet port 18.7, preferably through a flange connection 18.9. On the other side, the housing 18.6 is connected, via its outlet port 18.10, to the inlet port 18.11 of an also approximately balloon-like turbine housing 18.12 of the turbine 18.3 containing a double rotor 18.13, preferably also through a flange joint 18.9.

On its outlet side or at its outlet port 18.14, the turbine housing 18.12 is connected to a drain pipe 37, also through a flange joint 18.9. The drain pipe 37 is provided with a flaring diffusion portion 18.16 on its end turned toward the turbine, the drain pipe 37 then having, in its further course, a constant cross-section or diameter and being connected to other provided systems of a waste incineration and processing plant as well as to diverse gas cleaning apparatus and devices.

A high-pressure tank 18.18, which is configured and arranged concentrically, is located in the balloon housing 18.6, said high-pressure tank having substantially the shape of a pear and being, with its turned out or axially extended port end 18.19, configured and generally arranged in such a manner that it stands or ends near its outlet port and as a result thereof, near the outlet port 18.10 of the housing 18.6 and, as a result thereof, near the inlet port 18.11 of the turbine 18.3.

As can be seen from FIG. 6, a manifold 18.20 is provided at the closed inlet-sided end of the high-pressure tank 18, meaning practically at its bottom side, said manifold being discussed in closer detail with reference to the FIGS. 7 and 8. On the one side, the manifold 18.20 opens into the interior of the tank and is on the other side connected to a water tank 18.22 via an inlet line 18.21, a pump 18.23 in the line 18.21 delivering to the manifold 18.20 the cleaned process water contained in the water tank. For its major part, the cleaned process water contained in the tank 18.22 is introduced through a line 18.24 that originates from a water cleaning stage of the system or of the plant or that is supplied at need from the corresponding water reservoir. Additionally, water condensed out of the turbine 18.3 is fed into the water tank 18.22 via a line 18.25.

A double turbine rotor 18.13, which is, substantially or rather in the largest sense, configured mirror-symmetrical with respect to the housing center and to the rotor itself and which substantially also has or comprises increased dimensions or diameter, and then accordingly reduced dimensions or diameter, is concentrically arranged in the housing 18.12 of the turbine 18.3. The rotor input is located in proximity to the inlet port 18.11 of the turbine and thus at the same time in proximity to the port end 18.19 of the high-pressure tank 18.18. The exit 18.28 of the turbine rotor 18.13, which extends axially in the opposite direction, is located in corresponding proximity to the outlet port 18.14 of the turbine or of the turbine housing 18.12 and thus to the inlet of the diffuser portion 18.16 of the drain pipe 37. It can be seen that the maximum diameter of the turbine rotor is concurrently disposed, in its central portion of maximum circumference or in its crown 18.27, so as to mate the zone of greatest diameter of the housing 18.12.

The turbine rotor 18.13 is thereby connected to the permanent magnet generator 18.4 through its driven shaft 18.29. This generator 18.4 has three stages 18.31 which are automatically added to the circuit according to need or to the torque applied. Two direct current lines 18.33 and 18.34 lead from the generator 18.4 to the electrodes 18.36 and 18.37 of a separating device 18.35. In this device 18.35 occurs the physical separation of waste water fed through a line 18.38, e.g., of the waste water originating from the trash silo of a waste incineration and processing plant. Through the electrolytic reactions or splitting the impurities deposit in the form of slurry at the bottom of the tank of the device 18.35 and are evacuated via a line 18.38. The physically cleaned water is evacuated through a line 18.39 and supplied to further processing whilst the excess oxygen and hydrogen generated is transmitted to the auxiliary burner of the carburetor of the waste incineration and processing plant or to an internal combustion engine, via the lines 18.40 or 18.41.

From FIG. 6 it can be seen how the manifold 18.20 is arranged on the concentric housing 18.6 of the steam generator 18.2, arranged on the high-pressure tank 18.18, the inlet side of said manifold being protected by a cone 18.47 that at the same time distributes evenly the gas flow entering the housing 18.6 of the steam generator 18.2 over the outer surface of the tank 18.18.

FIG. 7 shows in detail how the manifold 18.20 consists of a guide pipe 18.28 which projects into the interior of the tank 18.18 and is fastened to the tank 18.18 via a flange 18.49 with gasket 18.50 and to which the inlet line 18.21 is connected on the outer side with an intermediate gasket 18.51

On the end side of the guide pipe 18.48, at a small distance therefrom, a manifold disc 18.55 is concentrically disposed, which has a bearing pipe 18.54 that projects axially into the bore 18.53 of the guide pipe 18.48 in such a manner that an annular water guide 18.56 forms. Additionally, an annular pocket 18.57 and 18.58 is respectively provided in the bore 18.53 of the guide pipe 18.48, at a respective end of the pipe section corresponding to the bearing pipe 18.54, the water passing by being caused to dam up in these annular pockets, which play the part of a water bearing as a result thereof. On the end side of the guide pipe 18.48 there is additionally provided an outward inclined portion 18.59 which causes the bore 18.53 to flare so that the water flowing from the water guide 18.56 is evacuated to the outside in a widened stream, thus impinging the incident flow surface 18.30 of the manifold disc 18.55 against which the water flows in a wider flow.

As can be seen from FIG. 8, axially protruding, spiral-shaped water guiding edges 18.61 are provided on the water-struck surface 18.60, the water flow exiting the water guide pushing onto said edges so that the manifold disc is caused to rotate.

It can be further seen from FIG. 7 that the bearing pipe 18.54 has an inner water guide 18.63 in the end side widened portion of which there is provided an annular pocket 18.64. In this pocket projects, at a small distance therefrom, a conical bearing cone 18.65 so that water flowing through the water guide 18.63 impinges the bearing cone 18.65 and forms a water bearing through backflow in the annular pocket 18.64. The bearing cone 18.65 is thereby axially slidably retained on a bar 18.68 via a threaded pin 18.66 with counternut 18.67, said bar being fastened to the flange 18.49. As a result, one has a three-point water bearing (18.57, 18.58, 18.64) that keeps the manifold disc 18.55 stable and prevents it from wobbling.

Thus, it can be generally seen that the manifold 18.20 forms an inherently compact unit that can be inserted as such from the outside and can thus be readily exchanged and fastened to the tank 18.18 via the flange 18.49 by screws for example. In the possible event of failures or necessary changes in the setting of the axial position of the bearing cone 18.65 or even in case the manifold unit needs to be exchanged altogether, it is merely necessary to untighten some screw connections in order to readily perform the necessary work.

The hot gas-steam generator 1 works as follows:

The hot gas 18.43 flowing or supplied from a trash gasifier for example via the supply pipe 19 enters the housing 18.6 via the inlet port 18.7 at a temperature of about 400° C. to 500° C. and flows around the high-pressure tank 18.18. It can be seen that at first the cross section widens significantly at the entrance and that later, in the zone of the evacuation port 18.10, the cross section narrows again so that the flow behavior of the hot gas is subject to corresponding changes. By causing the hot gas to flow about the high-pressure tank, the tank is heated accordingly so that the water sprayed into the manifold 18.20 evaporates immediately or explosively and is pushed or ejected toward the port end 18.19 of the tank. Through the corresponding pressure situations and also through the corresponding cross section reductions, the steam 18.44 exits the tank 18.18 and flows into the inlet port 18.11 of the turbine under quite high a pressure and at high speed. At the same time, the hot gas 18.43 also flows concentrically out of the housing 18.6 and into the inlet port 18.11 of the turbine, whereupon the steam 18.44 and the hot gas 18.43 mix, in particular when they are entering the turbine rotor rotating under the action of hot gas and steam. A hot gas-steam mixture forms that flows expanding through the first half of the turbine rotor and is then guided or flows compressing in the second half thereof until it flows out again through an outlet port 18.14 of the turbine, which is substantially of the same size as the inlet port 18.11. The hot gas-steam mixture, which was subject to the movements of rotation by the turbine rotor in addition to compression, expansion and again compression, has experienced different pressure and speed conditions and has been mixed strongly as a result thereof so that a pre-reaction has taken place in the mixture. Additionally, this pre-reacted mixture is caused to expand again when entering the diffuser portion 18.16 of the drain pipe 18.15 so that another mixing and reaction step takes place.

Thanks to the fact that a negative pressure prevails in the drain pipe 37, said negative pressure being caused e.g., by the exhaust fan of a gas cleaning stage 40 mounted downstream thereof, the through flow of the hot gas and of the steam or of the hot gas-steam mixture 18.45 takes place optimally, without any backflow, as this is mostly the case with current turbines, this causing, as it is known, the high efficiency losses to occur. Through the suction or the negative pressure in the drain pipe 37, the turbine 18.3 operates under best conditions so that its efficiency reaches or may achieve a hitherto never achieved high degree of efficiency with these steam turbines.

As can be seen in FIG. 9, in a first embodiment, the downdraft apparatus 38 has in its upper region a cooling and cleaning unit 60 that consists of an upper cover part 61 and of a lower base part 62, which form together a double cone housing 63. In this housing 63 there are disposed two conical wall elements 64 and 65 which also have a flaring conic shape, but with differing cone angles. The upper wall element 64 has a larger angle than the cover part 61 whilst the lower wall element 65 has a smaller conicity than the wall element 64 and it can be seen that the conicity of the wall element 65 coincides approximately with the conicity of the cover part 61. As a result, different cross sections of the passageway are provided, namely in the upper part, at the entrance, a first surface 66 the cross section of which equals the cross section the gas-steam mixture penetrating inlet pipe 37. Toward the second one 67, there is a very strong constriction or compression, followed by a great diffusion before a new constriction and, as a result thereof, compression is provided again in the region of the third surface 68.

A nozzle 71, 72 or 73 is respectively disposed centrically at the upper side of the conical wall elements 64 and 65 and of the cover part 61, said nozzles communicating through one lines 74 with the lower collecting tray 77 of the downdraft apparatus 38.

Now, humid air-steam mixture, which comes from the top via the line 37, enters the device; at the same time, the process liquid (water with reactant) is centrically sprayed into the device through the nozzles 71, 72, 73, diffusion taking place through the widening conicity of the housing or of the cover part 61 as well as through the atomization and the temperature drop in the first stage.

Through the differing conicities of the cover part 61 and of the wall element 64, the passage becomes narrower and compression takes place from the first surface 66 to the second surface 67.

From 67 to 68, expansion/diffusion takes place since the cone 65, which is located below, has a small angle. As a result, pressure and speed change, the pressure increases and the speed drops. The liquid-gas mixture, which is caused to flow under high pressure through the surface 67 into the widened space located there beneath is subjected to very strong turbulences and is additionally sprayed with process liquid and then strikes the other, slightly narrower cone of the wall element 65.

At the surface 68, the liquid-gas mixture again strikes a narrowed cross-section between the cone 62 and the now conically narrowing housing base 62 so that the speed and pressure conditions change again so that there is again a downdraft effect, i.e., swirls/turbulences. Process liquid is again injected centrically, so that the mixture is strongly caused to expand, this resulting in a corresponding increase in the surface size and, as a result thereof, in great cleaning effect. Through the increased surfaces and the process liquid injected, much energy is destroyed, the temperature being reduced from about 300° C. to 60° C. in a device having a double cone housing with two inner conical walls.

If, as shown in FIG. 10, several such device parts, i.e., several double cone housings with interior conical walls are arranged, the temperature can be reduced from about 500° C. to 60° C. Through the three cones, which are flaring respectively in the direction of flow, namely the upper housing wall, the two conical walls and the lower housing wall, which is conical in the opposite direction, one has six surfaces that are permanently wetted by the process liquid so that one has large reaction surfaces. In addition thereto, an extremely large reaction surface forms through the foam bubbles due to the strong expansion during the swirl at the passages between the first and the second conical wall 64 and 65 with the housing walls 61, 62. Moreover, the repeated pressure conditions (pressure changes) also have their effect so that a very high affinity of the gas molecules with the reactant of the process liquid is obtained.

The cleaned gases exiting the lower side of the housing base part 62 are drawn by the line 76 and flow into the gas cleaning stage 40 thanks to the suction effect of the fan 52, as can be seen from the FIGS. 1 through 2.

The process liquid forming thereby runs or drips downward, is collected by the hopper tray and flows into the collecting tray 77, the slurry 78 contained therein collecting at the bottom from which it can be evacuated via the lines 79.

As a result, the downdraft apparatus performs three tasks in the system, namely:

1. it causes the temperature to drop e.g., from approximately 500° C. to 60° C.

2. it adsorbs the gases pre-reacted by the hot gas-steam generator.

3. it accommodates pressure fluctuations in the flow of raw gas.

As can be seen in FIG. 9 but also in FIG. 2, the annular housing 20 of a desalination device 26 is arranged at the upper side of the downdraft apparatus 38 so as to concentrically enclose the drain and feed pipe 37. This housing 20 is also configured in the shape of a double cone, like the housing(s) 36 of the cooling and cleaning units 60 of the downdraft apparatus, only the upper conical side being used for desalination here, whilst the lower conical part is open toward the supply pipe 37, so that a strongly widened passageway cross section with corresponding diffusion and, as a result thereof, further influence on the gas-steam mixture is provided. Process water from the water reservoir (see also FIG. 2 in this respect) is introduced via the line 21 into the annular space 80 of the housing 20 of the desalination device where it evaporates quickly under the action of the heat of the gas-steam mixtures flowing through the line 37. The steam generated is evacuated via the line 25 which transfers the condensed water on the one side via a condenser 81 to the filter 28 and from there further in drinking water quality 29. In addition thereto, the condensed steam is evacuated from the line 25 into the tank 30 from which it is used to feed i.a. the evaporator of the hot gas-steam generator 18. The salt depositing during evaporation on the floor of the annular space 80 is then removed from the desalination device via a salt evacuation device, e.g., with the help of a scraper that has not been illustrated herein.

Finally, FIG. 10 shows a downdraft apparatus 38 in which there is not only provided a cooling and cleaning unit 60 at the upper side of the apparatus, but three units disposed vertically on top of each other so that the gas-steam mixture entering through the line 37 is cooled and cleaned three times.

### REFERENCE NUMERALS

1. water bath

2. scale

3. sluice

4. bunker

5. conveyor belt

6. crusher

7. slurry silo

8. slurry dehydration

9. conveyor

10. piston press

11. metal separator silo

12. physical separator

13. chamber filter press

14. trash storage hopper

15. fusion carburettor

16. slag processing

17. line (recycling)

18. hot gas-steam generator

19. line (outlet/inlet)

20. annular housing

21. line

22. water reservoir

23. line

24. cold and ice production

25. line

26. desalination device

27. line of desalinated water

28. filter

29. line (drinking water)

30. water tank

31. line

32 air cleaning stage (plant, halls)

33. line (air evacuation)

34. - - -

35. water processing stage (WAS)

36. thermal oil exchanger

37. line

38. downdraft apparatus

39. exhaust cleaning

40. gas cleaning

41. motor/turbine

42. gas liquefaction

43. supply tank

44. central reception of the matter

45. line

46. line

47. line

48. line to the discharge system

49. line

50. heat exchanger

51. - - -

52. exhaust fan

53. negative pressure tank

54. air-gas controller

55. air guiding pipe (of phys. sep.)

56. dynamic cylinders

57. foam generator

58. foam decomposition device

59. - - -

60. cooling and cleaning unit

61. cover part

62. base part

63. housing

64. wall element

65. wall element

66. ^{st} surface

67. 2^{nd} surface

68. 3^{rd} surface

69. - - -

70. collecting tray hopper

71. nozzle

72. nozzle

73. nozzle

74. line

75. pan

76. line

77. collecting tray

78. slurry

79. slurry line

80. annular space

81. condenser

82. salt evacuation

15.1 hopper

15.2 pusher system

15.3 housing jacket

15.4 grate

15.5 high-temperature balls

15.6 collecting space

15.7 metal alloy

15.8 slag

15.9 guide cylinder

15.10 gas guiding channel

15.11 ports

15.12 arcuate notches

15.13 roof

15.14 - - - (gas evacuation pipe=19)

18.1 device (HGDG)

18.2 steam generator

18.3 turbine

18.4 generator

18.5 drain pipe/inlet pipe

18.6 (balloon) housing

18.7 inlet port

18.8 - - - (inlet pipe=19)

18.9 flange connection

18.10 outlet port

18.11 (turbine) inlet port

18.12 (turbine) housing

18.13 (double) turbine rotor

18.14 outlet port

18.15 - - - (drain pipe=37)

18.16 diffusor portion

18.17 - - -

18.18 high-pressure tank

18.19 port end

18.20 (water) distributor

18.21 inlet line

18.22 water tank

18.23 pump

18.24 inlet pipe from water reservoir

18.25 outlet pipe from turbine

18.26 entrance

18.27 crown

18.28 exit

18.29 driven shaft

18.30 - - -

18.31 stages

18.32 - - -

18.33 electric line

18.34 electric line

18.35 (phys. separation=12)

18.36 electrode (cathode)

18.37 electrode (anode)

18.38 line

18.39 line

18.40 line

18.41 line

18.42 - - -

18.43 hot gas

18.44 steam

18.45 hot gas-steam mixture

18.46 - - -

18.47 cone

18.48 guide pipe

18.49 flange

18.50 gasket

18.51 gasket

18.52 - - -

18.53 bore

18.54 bearing pipe

18.55 distribution disc

18.56 water guide, outside

18.57 annular pocket

18.58 annular pocket

18.59 inclined portion

18.60 surface struck by the flow

18.61 water guiding edges

18.62 - - -

18.63 water guide, inside

18.64 annular pocket

18.65 bearing cone

18.66 threaded pin

18.67 counternut

18.68 bar

1. A method of generating effective energy by gasifying waste wherein
Refuse such as urban waste is introduced into a shaft-type smelting gasifier (15), is dried in counterflow, degassed and gasified with the solid residual matter being melted, the molten residue being evacuated and dust-containing raw gas being drawn at the top,
wherein the hot raw gas is cleaned and cooled, caused to flow through a separation zone and subjected to electrostatic separation, the obtained gas being next transferred to a burner or to overall effective energy generation (18),
wherein the hot raw gases drawn from the smelting gasifier (15) are supplied to a hot gas-steam generator (18) wherein steam is added and mixed to the hot gas and this hot gas-steam mixture is caused to flow, by way of the double rotor (18.13) to a turbine (18.3) that drives a current generator (18.4), a pre-reaction taking place at the same time,
wherein the pre-cleaned hot gas-steam mixture is introduced thereafter into a downdraft apparatus (38) in which, using injected water mixed with reactant and repeating expansions and compressions with foaming, the mixture is cooled and pre-cleaned, said pre-cleaned gas being drawn and the liquid collected,
wherein the pre-cleaned gas is supplied to a gas cleaning stage (40) in which the gas is foamed with reactant and defoamed again,
and wherein finally the cleaned gases are supplied to further energetic use, e.g., to the combustion in a motor (41).

2. The method as set forth in claim 1,
wherein, by arranging a guide cylinder (15.9) provided with roofed radial openings (15.11) in the gasification zone of the smelting gasifier (15), the material to be gasified glides downward in the guide cylinder whilst the released gases flow preferably upward in the gas-carrying channel (15.10), thereby flowing radially out of the openings.

3. The method as set forth in claim 1,
wherein, in the hot gas-steam generator (18), the steam is generated in the hot gas-carrying feed line mounted upstream of the turbine (18.3), with process water being introduced centrally or axially so that the hot steam enters the turbine (18.3) together with the hot gas, mixing with it and undergoing pre-reaction, flows through said turbine and flows out of it again.

4. The method as set forth in claim 3,
wherein negative pressure prevails in the lines carrying the gas-steam mixture, said negative pressure being caused to occur by the suction effect of the fan of the gas cleaning stage (40) mounted downstream thereof.

5. The method as set forth in claim 1,
wherein the turbine (18.3), which is driven by the energy of the hot gas-steam mixture, drives a multiple stage current generator (18.4), the direct current generated being preferably used for physical separation (12) with electrostatic decomposition of the process water of the plant and the excess oxygen and hydrogen being preferably supplied to the auxiliary burner (15.16) of the smelting gasifier (15).

6. A plant for carrying out the method as set forth in claim 1, with a shaft-type generator-smelting gasifier (15), with a gas scrubber (40) and with an electrostatic separator,
wherein a hot gas-steam generator (18) is connected to the smelting gasifier (15), said hot gas-steam generator consisting of a steam generator (18.2), of a turbine (18.3) with a double rotor, and of a generator (18.4) driven by the latter,
wherein the drain pipe (37) of the hot gas-steam generator (18) is connected to a downdraft apparatus (38) that is equipped with several conical inclined walls and in which there are provided in steps centrically disposed nozzles for introducing by atomization water mixed with reactant and forming at least one cooling and cleaning unit (60) for further cooling and separating the hot gas-steam mixture,
and wherein the gas outlet of the downdraft apparatus (38), is connected to a gas cleaning stage (40) that generates a negative suction pressure with a ventillator in the downdraft apparatus (38) through the hot gas steam generator (18) to the smelting gasifier (15), the gas cleaning device (gas washer) (40) comprising a station for foaming the gas with reactant and thereafter a station for defoaming (foam decomposition station) that is connected to a motor (41) via a gas line for the cleaned gas.

7. The plant as set forth in claim 6,
wherein, inside the gasification zone of the smelting gasifier (15) there is disposed, concentrically with the gasifier housing jacket (15.3) and at a radial distance therefrom, a guide cylinder (15.9) provided with radial openings (15.11) in such a manner that the material to be gasified is located inside the guide cylinder (15.9) and glides downward whilst an annular or cylindrical gas-carrying channel (15.10), into which the formed gas enters and is evacuated toward the top, is formed between the guide cylinder (15.9) and the housing jacket (15.3).

8. The plant as set forth in claim 7,
wherein the radial openings (15.11) of the guide cylinder (15.9) are perforations that are pushed outward to form a roof, with an arcuate portion, which is at least slightly pushed inward to form a roof, forming a protection for the port, whilst the guide cylinder (15.9) extends at its upper end at least as far as the center of the gas evacuation pipe (19) and having at its upper end a conical widened portion (15.15), the upper outer border extending radially substantially as far as the housing jacket.

9. The plant as set forth in claim 6,
wherein the hot gas steam generator (18) possesses a steam generator (18.2), a turbine (18.3) with a double rotor (18.13) and a generator (18.4), said steam generator (18.2) being implemented as a balloon- or pear-shaped housing (18.6) mounted upstream of the inlet (18.11) to the turbine (18.3), a pear-shaped high-pressure tank (18.18) being disposed concentrically in said housing in such a manner that the raw hot gases (18.43) flow around it and heat it and that it points, with its constricted opening end (18.19), toward the rotor (18.13) of the turbine in the immediate proximity to which it ends, the high-pressure tank (18.18) being connected to a water feed line (18.24) for supplying the water to be evaporated.

10. The plant as set forth in claim 9,
wherein the water feed line (18.24) opens out centrically/axially in the high-pressure tank (18.18) on the side of the gas inlet, the water being introduced evenly, in fine distribution, into the high-pressure tank (18.18) via a manifold (18.20), a manifold (18.20) for radial distribution of the axially introduced water being disposed on the floor of the tank (18.18) so as to project thereinto, said manifold having a coaxial manifold disc (18.55) on which the water, which flows in axially via a guide pipe (18.48), impinges and is finely distributed in radial direction.

11. The plant as set forth in claim 10,
wherein the manifold disc (18.55) is concentrically retained in the guide pipe (18.48) at its bearing pipe (18.54) via water bearings (18.18, 18.57, 18.58) and wherein there are provided tangential or spiral-shaped water guide edges (18.61) on the flow-struck surface (18.60) of the manifold disc (18.55), said water guide edges being adapted to cause the disc to rotate and wherein an axially adjustable bearing cone (18.65) is provided coaxially on the outer end side of the manifold disc (18.55), said bearing cone projecting into an inner water guide (18.63) of the bearing pipe (18.54) of the manifold discs (18.55), an annular pocket (18.64) forming a water bearing being provided in the widened end of the water guide (18.63).

12. The plant as set forth in
claim 6, wherein the drain pipe (37) has a diffuser portion (18.16) widening in the drain direction so that negative pressure can be installed in the drain pipe (37).

13. The plant as set forth in claim 10,
wherein the water feed line (18.48) is connected to a water tank (30) in which there is introduced cleaned process water from the water reservoir (22) of a water processing stage (35) of the waste gasification plant.

14. The plant as set forth in claim 9,
wherein the generator (18.4) driven by the driven shaft (18.29) of the turbine (18.3) is a permanent magnet generator, the current generated serving inter alia for operating a device for physical separation (12) with oxidation unit (electrolysis), said generator (18.4) comprising several stages (18.31), which may switch on their own for different torque acceptance.

15. The plant as set forth in claim 6,
wherein the downdraft apparatus (38) is equipped with at least one cooling and reaction unit (60) that is made from a double cone housing (63) and from at least two conical wall elements (64, 65) which are vertically placed on top of each other in a spaced-apart relationship, a nozzle (71, 72, 73) being respectively provided in the center for spraying water mixed with liquid, preferably with reactant, onto the conical wall elements and the intermediate space, the conical wall elements being concurrently disposed at different angles with respect to each other in such a manner that there is always provided a cross section constriction with an approximately nozzle-type narrow passageway, followed by a considerable widening of the cross section in such a manner that a very strong swirl can be effected in the mixture flowing therethrough.

16. The plant as set forth in claim 15,
wherein a collecting tray (77) for collecting the separating liquid is provided below the cooling and cleaning unit (60) of the downdraft apparatus (38), a line (74) leading back from said collecting tray to the nozzles (71, 72, 73) of the cooling and cleaning unit (60) and wherein there is provided a line (76) that communicates with the gas cleaning stage (40) for the cleaned gases exiting the cooling and cleaning unit (60) on the underside thereof.

17. The plant as set forth in claim 15,
wherein an annular housing (20) of a desalination device (26) is arranged on the feed pipe (37) of the downdraft apparatus (38), a line (21), which is connected with the water preparation (35), opening out in said desalination device for feeding cleaned water and wherein there is provided a line (25) on the annular housing (20) for evacuating the steam generated by the evaporating water, said line being connected to a condenser (81), which is followed by a filter (28) and by a drinking water line (29), and wherein a slide for removing the salt is provided in the annular housing (20).

18. The plant as set forth in claim 6,
wherein there is provided a device for processing water (35) to which the contaminated water originating from the various stations of the plant is fed, cleaned and transferred to a water reservoir (22) for cleaned water.
